(19) United States
(12) Patent Application Publication
(10) Pub. No.: US 2022/0394941 A1
(43) Pub. Date: Dec. 15, 2022

(54) EMITTER AND DRIP IRRIGATION TUBE

(71) Applicant: Enplas Corporation, Saitama (JP)

(72) Inventors: Koki ONO, Saitama (JP); Atsushi TAKAHASHI, Saitama (JP); Yuki TAGUCHI, Saitama (JP)

(21) Appl. No.: 17/777,295

(22) PCT Filed: Nov. 12, 2020
(86) PCT No.: PCT/JP2020/042279

§ 371 Date: May 17, 2022

(30) Foreign Application Priority Data
Nov. 19, 2019 (JP) 2019-208871

(51) Int. Cl. A01G 25/02

(52) U.S. Cl. CPC A01G 25/023

(57) ABSTRACT

The present invention addresses the problem of providing: an emitter that can be placed within a tube without aligning discharge parts of the emitter, is reduced in thickness while having a function for adjusting the flow rate, and is less likely to inhibit irrigation fluid flow. An emitter for solving the above problem is joined to the inner wall surface of a tube through which an irrigation fluid flows, and is used to discharge the irrigation fluid within the tube from a discharge port to the outside of the tube. The emitter has: at least one intake part; one discharge amount adjustment part; one discharge groove; and a plurality of discharge parts. The plurality of discharge parts are disposed symmetrically on both sides of the center of the emitter in a plan view.

### TECHNICAL FIELD

The present invention relates to an emitter and a drip irrigation tube having the emitter.

### BACKGROUND ART

A drip irrigation method is known as a method for cultivating plants. In the drip irrigation method, a drip irrigation tube is disposed on the soil where plants are planted, and irrigation liquid such as water, liquid fertilizer, and/or the like is dripped to the soil from the drip irrigation tube. The drip irrigation method has been increasingly attracting attention in recent years since the method can minimize the consumption rate of the irrigation liquid.

Normally, the drip irrigation tube includes a tube provided with a plurality of through holes for discharging the irrigation liquid, and a plurality of emitters (also called “drippers”) for discharging the irrigation liquid from the respective through holes (see, e.g., Patent Literature (hereinafter referred to as “PTL”) 1).

The emitter disclosed in PTL 1 includes a first member having an intake part for intake of irrigation liquid, a second member having a discharging part for discharging the irrigation liquid, and a film member disposed between the first member and the second member. The configuration of the emitter is such that the first member, the film member, and the second member are stacked on one another in this order. The emitter is joined to the inner wall surface of the tube. In the emitter described in PTL 1, the pressure of the irrigation liquid deforms the film member and causes the intake part to open, so that the irrigation liquid enters the emitter, flows through a pressure reducing channel between the intake part and the discharging part, and is discharged from the discharging part. The discharging part is disposed at a position shifted outward from the center of the emitter in the longitudinal direction.

### CITATION LIST

### Patent Literature

### PTL 1

Japanese Patent Application Laid-Open No. 2010-046094

### SUMMARY OF INVENTION

### Technical Problem

When attaching a plurality of emitters as described in PTL 1 to the inside of a tube, a plurality of emitters are joined to the inside of the tube at predetermined intervals. In addition, through holes are formed from the outside to the inside of the tube at positions corresponding respectively to discharging parts of the emitters, and the through holes are used as discharging ports of the irrigation tube. Therefore, it is necessary to dispose each of the emitters such that the discharging part is positioned at a predetermined position in the tube.

Here, when the discharging part is formed at a position shifted from the center of the emitter as in PTL 1, it is necessary to join emitters to the tube such that not only the fronts and backs of the emitters but also the orientations of discharging parts of the emitters are uniformly arranged in one direction. Therefore, there is a problem that the joining operation of the emitters is likely to be complicated.

Note that, in the emitter as in PTL 1, it is also conceivable to dispose the discharging part in the vicinity of the center of the emitter. However, in this case, it becomes necessary to dispose the structure for regulating the flow rate, various channels, the discharging part, and the like such that these parts overlap one another in the thickness direction. In such a configuration, the thickness of the emitter is increased, and the flow of the irrigation liquid is likely to be obstructed.

It is an object of the present invention to provide an emitter which can be installed in a tube without uniformly arranging an orientation of a discharging part of the emitter, and which has a function for regulating the flow rate, has a small thickness, and is unlikely to inhibit the flow of an irrigation liquid, and to provide a drip irrigation tube using this emitter.

### Solution to Problem

In order to solve the above problems, the present invention provides the following emitter:

An emitter for discharging an irrigation liquid in an irrigation-liquid-carrying tube at a fixed rate out of the irrigation-liquid-carrying tube from a discharging port of the irrigation-liquid-carrying tube that communicates between an inside and an outside of the irrigation-liquid-carrying tube, the emitter being configured to discharge the irrigation liquid in case that the emitter is joined to an inner wall surface of the irrigation-liquid-carrying tube at a position corresponding to the discharging port, the emitter including: at least one intake part for intake of the irrigation liquid; a discharge rate regulating part for regulating an amount of the irrigation liquid that is taken in from the at least one intake part and is to be discharged from the discharging port; one discharging groove connected to the discharge rate regulating part; and a plurality of discharging parts connected to the one discharging groove, the plurality of discharging parts being for discharging the irrigation liquid to the discharging port, in which the plurality of discharging parts are disposed at positions symmetrical with respect to a center of the emitter as seen in plan view.

In addition, the present invention provides the following drip irrigation tube:

A drip irrigation tube including: a tube including a discharging port for discharging an irrigation liquid; and the above-described emitter joined to an inner wall surface of the tube, in which the discharging port of the tube and one of the plurality of discharging parts of the emitter are disposed so as to face each other.

### Advantageous Effects of Invention

According to the emitter and the drip irrigation tube of the present invention, the emitter can be installed in the tube without uniformly arranging the orientations of the discharging parts of the emitter. In addition, because the thickness of the emitter is small despite having the function for regulating the flow rate, the flow of the irrigation liquid is unlikely to be obstructed.

### BRIEF DESCRIPTION OF DRAWINGS

FIG. 1A is a sectional view along an axis of a drip irrigation tube according to an embodiment of the present invention;

FIG. 1B is a cross-sectional view in a direction perpendicular to the axis of the drip irrigation tube;

FIG. 2A is a perspective view of the emitter for the drip irrigation tube illustrated in FIGS. 1A and 1B;

FIG. 2B is a perspective view of an emitter main body of the emitter illustrated in FIG. 2A;

FIG. 3A is a plan view of the emitter main body illustrated in FIG. 2B;

FIG. 3B is a front view of the emitter main body;

FIG. 4A is a bottom view of the emitter main body illustrated in FIG. 2B;

FIG. 4B is a sectional view taken along line A-A in FIG. 3A;

FIG. 5A is a perspective view of the emitter according to a variation;

FIG. 5B is a perspective view of the emitter main body of the emitter illustrated in FIG. 5A;

FIG. 6A is a plan view of an emitter according to another variation;

FIG. 6B is a sectional view taken along line A-A illustrated in FIG. 6A;

FIG. 7A is a plan view of an emitter according to a yet another variation;

FIG. 7B is a sectional view taken along line A-A illustrated in FIG. 7A;

FIG. 8A is a perspective view of an emitter according to a still another variation;

FIG. 8B is a perspective view of the emitter illustrated in FIG. 8A in which a film is rotated;

FIG. 9A is a plan view of the emitter illustrated in FIG. 8B;

FIG. 9B is a front view of the emitter;

FIG. 9C is a bottom view of the emitter; and

FIG. 10 is a plan view of an emitter according to an even another variation.

### DESCRIPTION OF EMBODIMENTS

Hereinafter, a drip irrigation tube will be described in detail based on a specific embodiment. However, the drip irrigation tube is not limited to the present embodiment.

[Configuration of Drip Irrigation Tube]

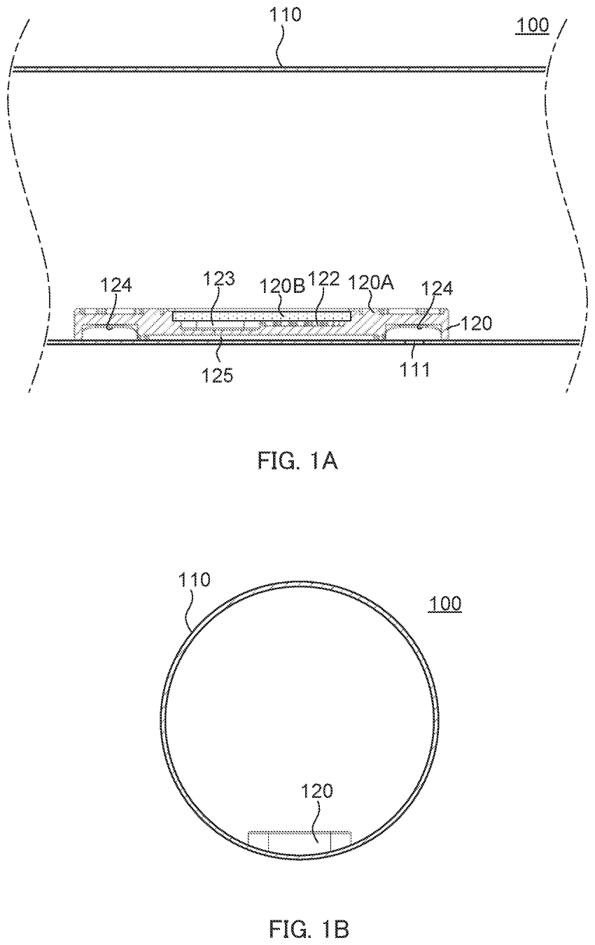

FIGS. 1A and 1B illustrate a configuration of drip irrigation tube 100 according to an embodiment of the present invention. FIG. 1A is a sectional view along the axial direction of drip irrigation tube 100 according to the present embodiment, and FIG. 1B is a cross-sectional view perpendicular to the axial direction of drip irrigation tube 100. Drip irrigation tube 100 of the present embodiment includes tube 110 having discharging port 111 for discharging an irrigation liquid, and emitter 120 joined to the inner wall surface of tube 110 at a position corresponding to discharging port 111.

Tube 110 is a pipe for carrying irrigation liquid. Normally, tube 110 is made of a resin, and the material of tube 110 is, for example, polyethylene such as linear low-density polyethylene, high-density polyethylene, and/or the like. Tube 110 may have any inner diameter as long as emitter 120 can be disposed inside tube 110 and can allow a sufficient amount of irrigation liquid to flow therethrough.

A plurality of discharging ports 111 for discharging the irrigation liquid are formed in the wall of tube 110 at a predetermined interval (e.g., 200 mm to 500 mm) along the axial direction of tube 110. The opening portion of each of discharging ports 111 may have any diameter as long as the irrigation liquid can be discharged at a desired flow rate, and the diameter is, for example, 1.5 mm A plurality of emitters 120 are joined to the inner wall surface of tube 110 at positions corresponding to discharging ports 111, respectively.

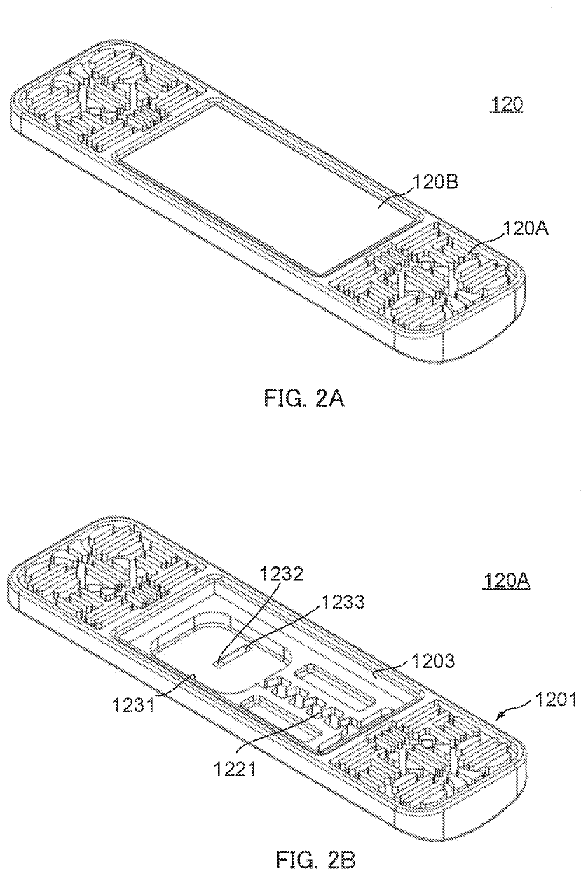

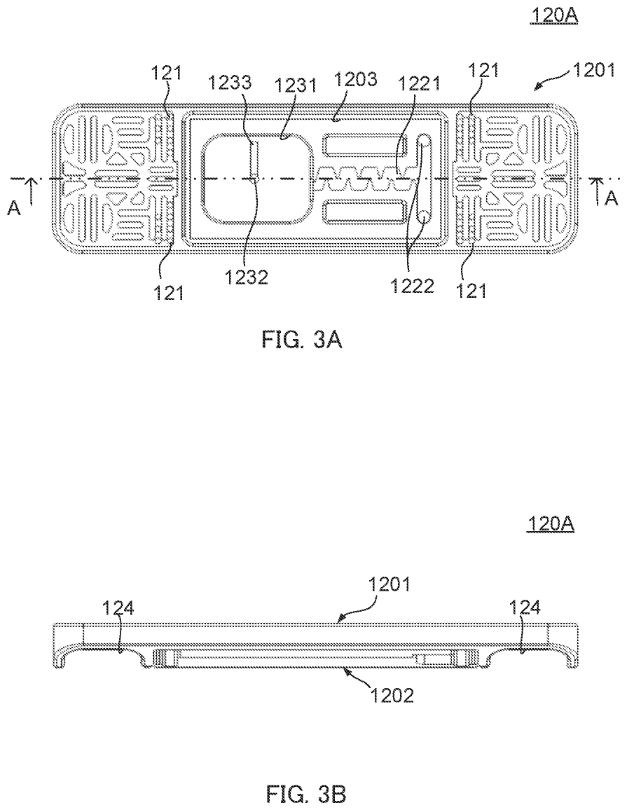

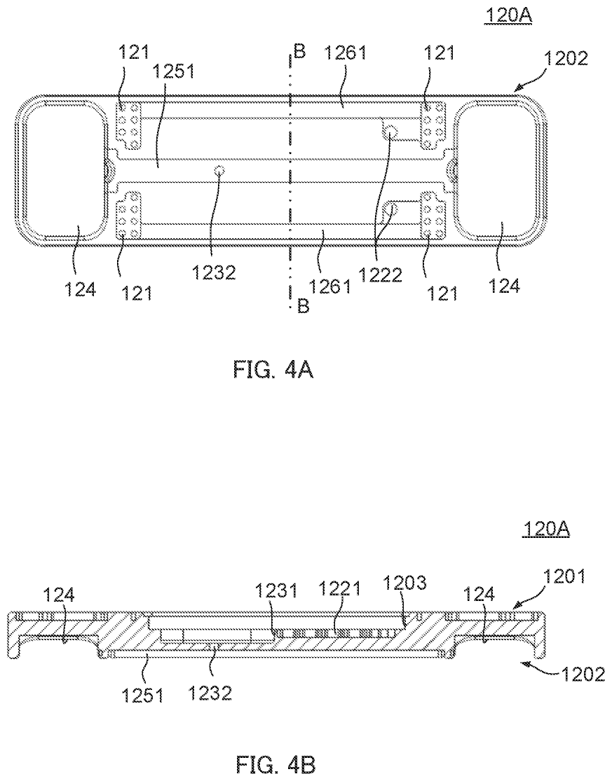

FIG. 2A is a perspective view of emitter 120 of the present embodiment. As illustrated in FIG. 2A, emitter 120 of the present embodiment includes emitter main body 120A and film 120B. FIG. 2B illustrates a perspective view of emitter main body 120A of emitter 120 from which film 120B is removed. Further, FIG. 3A illustrates a plan view of emitter main body 120A, and FIG. 3B illustrates a front view of emitter main body 120A. Further, FIG. 4A illustrates a bottom view of emitter main body 120A, and FIG. 4B illustrates a sectional view of this emitter main body 120A taken along line A-A in FIG. 3A.

As illustrated in FIG. 3A, four intake parts 121 for taking the irrigation liquid in emitter 120 are disposed in emitter 120. In addition, as illustrated in FIG. 1A, one pressure reducing channel 122 for reducing the pressure of the irrigation liquid taken in from intake parts 121, one discharge rate regulating part 123 connected to pressure reducing channel 122 for regulating the amount of the irrigation liquid to be discharged from discharging port 111 of tube 110, discharging channel 125 connected to aforementioned one discharge rate regulating part 123, and two discharging parts 124 connected to discharging channel 125 are disposed.

In drip irrigation tube 100, the surface of emitter 120 on the intake part 121 side is disposed on the irrigation liquid side, and the surface on the discharging part 124 side and on the discharging channel 125 side is disposed to make contact with tube 110.

The size and shape of emitter 120 can be appropriately selected in accordance with the inner diameter of tube 110, the discharge rate of the irrigation liquid, and the like. The shape of emitter 120 in plan view of the present embodiment is a substantially rectangular shape with four corners rounded, but is not limited to this shape. In the present embodiment, the length of emitter 120 in the long side direction is 35 mm, the length of emitter 120 in the short side direction is 10 mm, and the height of emitter 120 is 3 mm, but the emitter is not limited to this dimensions.

Emitter main body 120A of the present embodiment is formed of a resin material. Examples of the resin material include polyethylene such as linear low-density polyethylene, high-density polyethylene, and/or the like, polypropylene, silicone, and industrial materials having rubber elasticity. Examples of the industrial materials having rubber elasticity include elastomer and rubber.

Emitter main body 120A has a substantially rectangular shape in plan view, and has first surface 1201 and second surface 1202 that have a relation between the front and the back with respect to each other. Mainly four intake parts 121 for taking in the irrigation liquid and first recess 1203 are disposed in first surface 1201 as illustrated in FIGS. 2B and 3A.

Each of intake parts 121 is a structure for taking the irrigation liquid in emitter 120, and in the present embodiment, is a through hole that communicates between first surface 1201 and second surface 1202 of emitter main body 120A. Intake parts 121 are connected to below-described introduction grooves 1261 in the second surface 1202 side of emitter main body 120A.

In the present embodiment, four intake parts 121 are disposed in emitter main body 120A. However, only one or more intake parts 121 need to be disposed in emitter main body 120A, and the number of intake parts is not limited. However, in case that a plurality of intake parts 121 are disposed in emitter main body 120A, the irrigation liquid can be taken into emitter 120 even in case that clogging or the like occurs in any of the intake parts. In addition, the periphery around each of intake parts 121 is roughened, and the roughening prevents ingress of impurities in the irrigation liquid into emitter 120. The shape of the roughening is not particularly limited.

In the present embodiment, in emitter main body 120A as seen in plan view, four intake parts 121 are disposed on the outer side of first recess 1203 in the longitudinal direction. Further, four intake parts 121 are disposed at substantially equal intervals from the center of emitter main body 120A as seen in plan view. However, the positions of intake parts 121 are not limited to such positions as long as a sufficient amount of irrigation liquid can be taken into emitter 120.

Further, in the present embodiment, each of intake parts 121 includes seven through holes. In case that each of intake parts 121 is a group of through holes having a relatively small opening diameter, impurities in the irrigation liquid are unlikely to be taken into emitter 120. However, the shape and the number of through holes of each intake part 121 are not particularly limited, and are appropriately selected in accordance with the opening diameter of each of the through holes and the desired discharge rate of the irrigation liquid.

First recess 1203 is disposed in a region including the center of emitter main body 120A, and is a region recessed from first surface 1201 of emitter main body 120A to assume a substantially rectangular parallelepiped shape. The depth of first recess 1203, i.e., the distance from first surface 1201 of emitter main body 120A to the bottom surface of first recess 1203 is set deeper than the thickness of film 120B to be described later.

First communication holes 1222, pressure reducing channel groove 1221, second recess 1231, second communication hole 1232, and discharge rate regulating groove 1233 are disposed in the bottom surface of first recess 1203.

First communication holes 1222 are a through hole for connecting below-described introduction grooves 1261 in second surface 1202 of emitter main body 120A to pressure reducing channel groove 1221. In the present embodiment, two first communication holes 1222 corresponding to two introduction grooves 1261 are disposed, but the number of first communication holes 1222 may be one, three, or more according to the shape of introduction grooves 1261.

Pressure reducing channel groove 1221 is a groove for connecting two first communication hole 1222 to second recess 1231. The space delimited by film 120B described later and pressure reducing channel 1221 serves as pressure reducing channel 122 for regulating the pressure of the irrigation liquid taken in from intake part 121.

In the present embodiment, pressure reducing channel groove 1221 includes a linear groove connecting together two first communication holes 1222 and extending along the transverse direction of emitter main body 120A and a zigzag-shaped groove that opens at one end in the linear channel, opens at the other end in second recess 1231, and extends along the longitudinal direction of emitter main body 120A. However, pressure reducing channel groove 1221 may have any shape as long as the pressure of the flowing irrigation liquid can be reduced to a desired range, and is not limited to the zigzag shape.

Further, the width, depth, and the like of pressure reducing channel groove 1221 may be constant from the first communication hole 1222 side to second recess 1231, or may be continuously or non-continuously changed as long as it allows a desired amount of irrigation liquid to flow therethrough.

Meanwhile, second recess 1231 is a region recessed from the bottom surface of first recess 1203 to assume a substantially rectangular parallelepiped shape, and is connected to one end of pressure reducing channel groove 1221 described above. In the present embodiment, the shape of second recess 1231 as seen in plan view is a substantially rectangular shape with four corners rounded. However, the shape of second recess 1231 as seen in plan view is not limited to the substantially rectangular shape, and may, for example, have any shape of a circular shape, a polygonal shape, and the like.

The depth of second recess 1231 is such a depth that below-described film 120B does not come into contact with the bottom surface of second recess 1231 in a state in which pressure from the irrigation liquid is not applied to the film, that is, in a state in which the irrigation liquid is not flowing through tube 110. This depth may be such a depth that when the pressure from the irrigation liquid in tube 110 increases, bent film 120B can come into contact with the bottom surface of second recess 1231 (in particular, with the opening end of second communication hole 1232 on the first surface 1201 side).

At the middle of the bottom surface of second recess 1231, second communication hole 1232 is opened, and discharge rate regulating groove 1233 is disposed to open at one end in second communication hole 1232.

Second communication hole 1232 is a through hole for connecting discharging groove 1251 disposed in second surface 1202 of emitter main body 120A to second recess 1231.

On the other hand, discharge rate regulating groove 1233 is a groove that is further recessed from the bottom surface of second recess 1231, and that opens at one end to second communication hole 1232. Discharge rate regulating groove 1233 is a groove for allowing a certain amount of irrigation liquid to flow into second communication hole 1232 even when the pressure of the irrigation fluid in tube 110 is increased and bent film 120B comes into contact with the opening end of second communication hole 1232 on the first surface 1201 side. The length, depth, and width of discharge rate regulating groove 1233 are appropriately selected in accordance with a desired discharge rate of the irrigation fluid. The depth and width of discharge rate regulating groove 1233 may be constant, or may be changed continuously or stepwise. Further, in the present embodiment, discharge rate regulating groove 1233 is disposed so as to extend along the transverse direction of emitter main body 120A, but the orientation of the discharge rate regulating groove is not particularly limited.

Meanwhile, two introduction grooves 1261 connected to intake parts 121, discharging groove 1251 connected to second communication hole 1232, and discharging parts 124 connected to discharging groove 1251 are disposed in second surface 1202 of emitter main body 120A as illustrated in FIG. 4A.

Introduction grooves 1261 are grooves linking the opening ends of above-described intake parts 121 on the second surface 1202 side to above-described first communication holes 1222 described above. Spaces delimited by introduction grooves 1261 and tube 110 serve as channels for allowing the irrigation liquid taken in from intake part 121 to flow toward the first communication holes 1222 side.

In the present embodiment, two introduction grooves 1261, each of which links two intake parts 121 to one first communication hole 1222 are disposed. However, the shape of each of introduction grooves 1261 is appropriately selected in accordance with the number of intake parts 121 and the number of first communication holes 1222. For example, introduction groove 1261 may be configured to link one intake part 121 and one first communication hole 1222, or may be configured to connect three or more intake parts 121 and one first communication hole 1222. The width and depth of introduction groove 1261 may be constant from the first communication hole 1222 side to second recess 1231, or may be continuously or non-continuously changed as long as the introduction groove allows a desired amount of irrigation liquid to flow therethrough.

Meanwhile, discharging groove 1251 is a groove linking second communication hole 1232 described above to each of two discharging parts 124. The space delimited by discharging groove 1251 and tube 110 serves as discharging channel 125 for allowing the irrigation liquid to flow from the second communication hole 1232 side to the discharging part 124 side. In the present embodiment, the channel opens at one end to second communication hole 1232 and opens at the other end to each of discharging parts 124 is disposed on a straight line, but the shape of discharging groove 1251 is appropriately selected in accordance with the number of discharging parts 124, the number of discharge rate regulating parts 123, and/or the like. For example, in case that emitter 120 includes a plurality of discharge rate regulating parts 123, discharging groove 1251 may be a groove linking the second surface side openings (second communication hole 1232 described above) of the plurality of discharge rate regulating parts 123 to the plurality of discharging parts 124. Further, for example, when the number of discharging parts 124 is three or more, discharging groove 1251 may branch into any shape such as a T shape or a cross shape.

Each of discharging parts 124 is a region that is recessed from second surface 1202 of emitter main body 120A to assume a substantially rectangular parallelepiped shape, and is connected to one end of discharging groove 1251 described above. In the present embodiment, the shape of each of discharging parts 124 as seen in bottom view is a substantially rectangular shape with four corners rounded, but the shape is not limited thereto, and may be, for example, a circular shape or the like. The depth of discharging part 124 may be any depth that does not interfere with an instrument for forming discharging port 111 from the tube 110 side, and is appropriately selected in accordance with a forming device or the like used for forming discharging port 111 of tube 110.

Here, two discharging parts 124 are disposed in emitter main body 120A of the present embodiment, which are disposed at positions symmetrical with respect to the center of emitter main body 120A as seen in plan view. The number of discharging parts 124 may be two or more, and although this number is not limited, an even number is preferable from the viewpoint of symmetry. When a plurality of discharging parts 124 are disposed symmetrically with respect to the center of emitter 120 as seen in plan view, it becomes unnecessary to uniformly arranging the longitudinal orientations of emitters 120 at the time of joining emitters 120 to tube 110.

Further, in the present embodiment, in emitter main body 120A as seen in bottom view, two discharging parts 124 are disposed outside above-described intake parts 121 and first recess 1203 in the longitudinal direction, first recess 1203 being disposed on the first surface 1201 side. That is, discharging parts 124 are disposed so as not to overlap pressure reducing channel 122, and discharging parts 124 are disposed so as not to overlap discharge rate regulating part 123. Further, in emitter main body 120A as seen in bottom view, two discharging parts 124 are disposed symmetrically with respect to the center line perpendicular to the longitudinal direction (line B-B in FIG. 4A). However, the positions of discharging parts 124 are not limited to the above-described positions. For example, two discharging parts 124 may be disposed diagonally in second surface 1202 of emitter main body 120A.

Meanwhile, film 120B in emitter 120 of the present embodiment only needs to be capable of covering the bottom surface of first recess 1203 in emitter main body 120A described above, and in the present embodiment is a substantially rectangular film. In addition, as described above, in the present embodiment, the depth of first recess 1203 in emitter main body 120A is greater than the thickness of film 120B. Therefore, when film 120B is disposed in first recess 1203, the upper surface of film 120B is lower by one step than first surface 1201 of emitter main body 120A. When the upper surface of film 120B is lower than first surface 1201 of emitter main body 120A, film 120B is unlikely to make contact with various devices or other emitters 120 when emitters 120 are joined to tube 110 or when emitters 120 are being transported. Thus, breakage or peeling of film 120B is suppressed.

The material of such a film 120B may be any flexible resin material. Examples of the resin material forming film 120B include polyethylene such as linear low-density polyethylene, high-density polyethylene, and/or the like, polypropylene, silicone, and industrial materials having rubber elasticity. Examples of the industrial materials having rubber elasticity include elastomer and rubber. The material of film 120B may be the same as or different from the material of emitter main body 120A.

Further, in the present embodiment, the bottom surface of first recess 1203 in emitter main body 120A is bonded to film 120B. The method of bonding is not particularly limited, and includes fusion, adhesion by a known adhesive, close adhesion by tackiness, and the like.

[Method of Manufacturing Drip Irrigation Tube]

Drip irrigation tube 100 can be manufactured by, for example, continuously manufacturing tube 110 using a tube material for tube 110, and by joining emitter 120 molded in advance to the inner surface of tube 110 at a predetermined position.

More specifically, a molten tube material is used to continuously fabricate tube 110. At this time, before the tube material is solidified, emitters 120 are fed at regular intervals from a feeder to the inner surface of tube 110, and the discharging part 124 side of emitter 120 is brought into contact with tube 110. Then, the tube material is solidified, so that emitters 120 disposed at predetermined positions are joined. Finally, by forming discharging ports 111 at regular intervals in tube 110, tube 110 for drip irrigation is obtained.

As described above, in case that the discharging part of the emitter is not disposed at the longitudinal center in the conventional emitter, it was necessary that the position of discharging port 111 formed from the outside of tube 110 corresponds to the position of the discharging part of the emitter. Therefore, it was necessary to uniformly arrange not only the fronts and backs of emitters but also the longitudinal orientations of the emitters when storing the emitters in the feeder.

In contrast, the present embodiment includes two discharging parts 124 disposed in the longitudinally outer part of emitter 120. Thus, regardless of the longitudinal orientation of emitter 120, each of discharging parts 124 is disposed in the longitudinally outer part of emitter 120. That is, even without uniformly arranging the longitudinal orientations of emitters 120 of the present embodiment, discharging parts 124 of emitters 120 are always disposed at positions at which discharging ports 111 of tube 110 are formed. Therefore, there is an advantage that uniform arrangement of the longitudinal orientations emitters 120 is not necessary when supplying emitters 120 to the feeder.

In emitter 120 of the present embodiment, only one of a plurality of discharging parts 124 (two discharging parts in the present embodiment) needs to be joined so as to communicate with discharging port 111 in tube 110. The irrigation liquid does not have to be discharged from one of discharging parts 124 of emitter 120 which does not face discharging port 111. Meanwhile, a plurality of discharging ports 111 of tube 110 may be formed for one emitter 120. In this case, emitters 120 are joined such that discharging ports 111 of tube 110 and discharging parts 124 of emitters 120 respectively face each other.

[Operation of Drip Irrigation Tube]

An overview of flow of irrigation liquid in above-described drip irrigation tube 100 is described. To begin with, an irrigation liquid to flow through tube 110 is taken in from intake parts 121. The irrigation liquid may be water, liquid fertilizer, agricultural chemical, or mixed liquid of two or more of them, for example. Since floating matters in the irrigation liquid are not allowed to enter the through holes of intake parts 121, the irrigation liquid from which the above-mentioned floating matters are removed is taken into emitter 120. The irrigation liquid taken in from intake parts 121 is supplied to pressure reducing channel 122 (the space between pressure reducing channel 1221 and film 120B described above) through introduction groove 1261 and first communication holes 1222.

Then, the pressure of the irrigation liquid is reduced in pressure reducing channel 122 and the irrigation liquid is supplied to discharge rate regulating part 123. Discharge rate regulating part 123 of the present embodiment is formed by above-described second recess 1231, second communication hole 1232, discharge rate regulating groove 1233, and film 120B. In the present embodiment, film 120B covering second recess 1231 functions as a diaphragm portion, and the bottom surface of second recess 1231 functions as a pedestal on which the diaphragm portion (film 120B) sits.

In discharge rate regulating part 123, the diaphragm portion (film 120B) is disposed away from the pedestal (the bottom surface of second recess 1231) when no load is applied to the diaphragm portion, and approaches the pedestal (the bottom surface of second recess 1231) when the pressure of the irrigation liquid in tube 110 is applied to the diaphragm portion.

More specifically, when the liquid pressure of the irrigation liquid is 0 MPa, the irrigation liquid does not flow inside emitter 120 and, therefore, no pressure difference (differential pressure) between the inside and the outside of emitter 120 is caused. Therefore, the diaphragm portion (film 120B) is not deformed.

When the hydraulic pressure of the irrigation liquid is low, the diaphragm portion (film 120B) slightly bends toward the pedestal (bottom surface of second recess 1231). However, since there is a sufficient gap between the diaphragm portion and the pedestal, the irrigation liquid is supplied through the gap from second communication hole 1232 to discharging parts 124 via discharging groove 1251. Then, the irrigation liquid is discharged from the discharging port of tube 110.

On the other hand, when the hydraulic pressure of the irrigation liquid increases, the gap between the diaphragm portion and the pedestal is reduced. Accordingly, the flow rate of the irrigation liquid that flows through the aforementioned gap decreases. Therefore, the flow rate of the irrigation liquid supplied to the discharging part 124 side is reduced.

In addition, when the hydraulic pressure of the irrigation liquid further increases, the diaphragm portion is greatly bent toward the pedestal side. When the diaphragm portion bends greatly, the diaphragm portion and the pedestal are brought into close contact with each other, the opening end of second communication hole 1232 that opens in the pedestal (the bottom surface of second recess 1231) is closed. However, one end of discharge rate regulating groove 1233 opens in second communication hole 1232. Accordingly, a predetermined amount of irrigation liquid flows into second communication hole 1232 via discharge rate regulating groove 1233, and the irrigation liquid is supplied to discharging part 124. At this time, the flow rate of the irrigation liquid to be discharged from discharging parts 124 (discharging port 111 of the tube) is smaller than that in the case where the liquid pressure is low.

[Effects]

In the emitter according to the present embodiment, a plurality of discharging parts are connected to one discharge rate regulating part. Further, a plurality of discharging parts are disposed at positions symmetrical with respect to the center of the emitter as seen in plan view. Therefore, when fixing emitters in the tube, the discharging parts are always disposed at desired positions even without uniformly arranging the orientations of the discharging parts. Thus, the manufacture of irrigation tubes is greatly facilitated. Further, in the emitter, it is not necessary to dispose the discharging parts, the discharge rate regulating part, and various channels (e.g., pressure reducing channel) such that the discharging parts, and the discharge rate regulating part and various channels overlap one another in the thickness direction. It is thus possible to reduce the thickness of the emitter. Therefore, it is unlikely that the emitter prevents the flow of irrigation liquid in the tube, and an excellent long-distance irrigation performance of the irrigation tube is achieved.

[Variation]

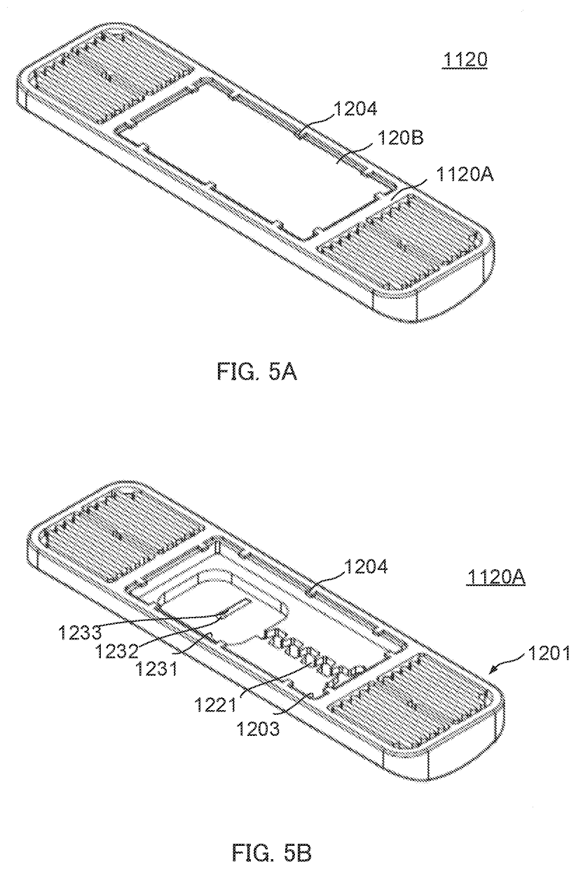

A variation of emitter 120 of the embodiment described above is illustrated in FIGS. 5A and 5B. FIG. 5A is a perspective view of emitter 1120 of the variation, and FIG. 5B is a perspective view of emitter main body 1120A in emitter 1120. Note that, emitter 1120 is the same as emitter 120 of the above-described embodiment except for a difference of the shape of first surface 1201 of emitter main body 1120A. Therefore, the same components are denoted by the same reference numerals, and a detailed description thereof is omitted.

In emitter main body 1120A of emitter 1120, a plurality of claw portions 1204 for fixing film 120B are disposed at an opening end of first recess 1203. Each of claw portions 1204 is a plate-shaped structure protruding from the opening end of first recess 1203 toward the opposite side of the opening end. The claw portions are disposed at substantially equal intervals on the inner circumference of first recess 1203. Claw portions 1204 are not particularly limited in width, length, thickness, and the like as long as the claw portions are capable of fixing film 120B to the bottom surface of first recess 1203 in emitter main body 1120A and do not interfere with the movement of the diaphragm portion (film 120B) during when the discharge rate of the irrigation liquid is regulated by discharge rate regulating part 123. It is preferable that claw portions 1204 be formed integrally with other regions forming emitter main body 1120A (for example, the side wall of first recess 1203).

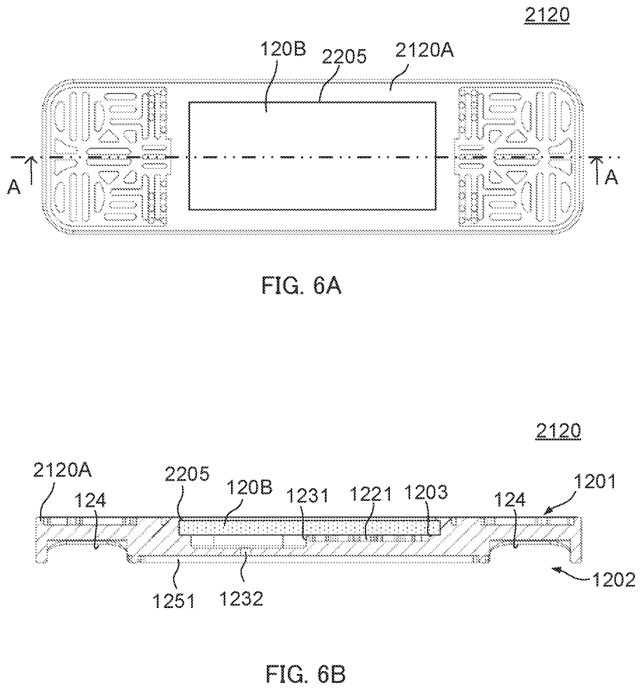

In addition, a further variation of emitter 120 of the embodiment described above is illustrated in FIGS. 6A and 6B. FIG. 6A is a plan view of emitter 2120 of the variation, and FIG. 6B is a sectional view taken along line A-A in FIG. 6A. Emitter 2120 is the same as emitter 120 of the above-described embodiment except for a difference of the shape of first surface 1201 of emitter main body 2120A. Therefore, the same components are denoted by the same reference numerals, and a detailed description thereof is omitted.

In emitter main body 2120A of emitter 2120, flange portion 2205 for fixing film 120B is formed on an upper portion of first recess 1203. Flange portion 2205 is a plate-shaped structure protruding from the opening end of first recess 1203 toward the opposite side of the opening end, and is disposed on the entire circumference surrounding first recess 1203. Flange portion 2205 is not particularly limited in projection width, thickness, or the like as long as it is capable of fixing film 120B to the bottom surface of first recess 1203 in emitter main body 2120A and does not inhibit the movement of the diaphragm portion (film 120B) during when the discharge rate of the irrigation liquid is regulated by discharge rate regulating part 123. In addition, flange portion 2205 may have a notch or the like in a part thereof. It is preferable that flange portion 2205 be formed integrally with other regions forming emitter main body 2120A (for example, the side wall of first recess 1203).

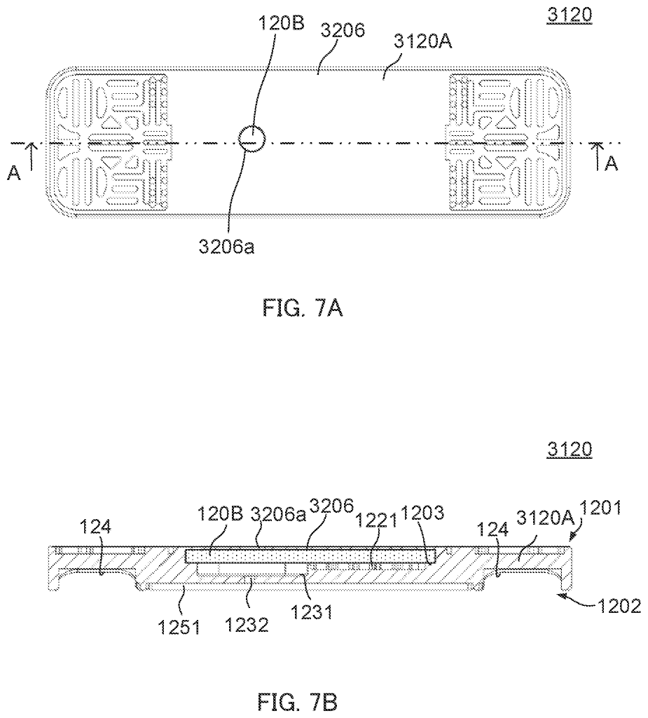

In addition, a further variation of emitter 120 of the embodiments described above is illustrated in FIGS. 7A and 7B. FIG. 7A is a plan view of emitter 3120 of the variation, and FIG. 7B is a sectional view taken along line A-A in FIG. 7A. Emitter 3120 is the same as emitter 120 of the embodiment described above except for a difference of the shape of first surface 1201 of emitter main body 3120A. Therefore, the same components are denoted by the same reference numerals, and a detailed description thereof is omitted.

In emitter main body 3120A of emitter 3120, cover portion 3206 is disposed on film 120B. Cover portion 3206 has a film-like structure covering film 120B and including through hole 3206a at a position corresponding to second communication hole 1232 of discharge rate regulating part 123, i.e., at an upper portion of second communication hole 1232. Note that, the diameter of the opening of through hole 3206a is not particularly limited as long as the pressure of the irrigation fluid flowing through tube 110 can be transmitted to film 120B exposed in through hole 3206a, that is, as long as film 120B can be used as the diaphragm portion in accordance with the pressure of the irrigation fluid as described above. In the present embodiment, through hole 3206a has a circular shape in plan view, but through hole 3206a may have a polygonal shape or the like in plan view. When cover portion 3206 is disposed on film 120B, film 120B is unlikely to make contact with other emitters and apparatuses, etc. Thus, it becomes easier to prevent damage or the like in film 120B. It is preferable that cover portion 3206 be formed integrally with other regions forming emitter main body 3120A (for example, the side wall of first recess 1203).

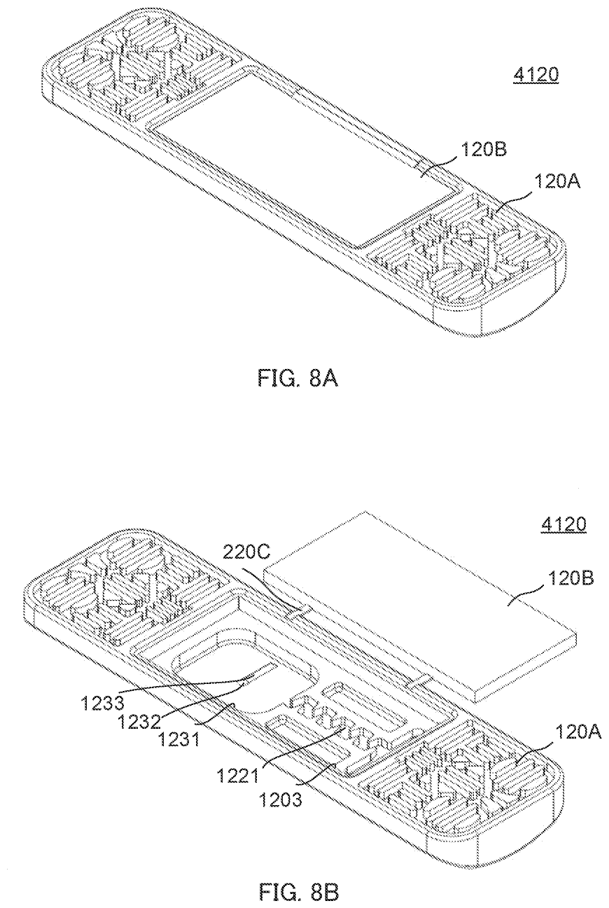

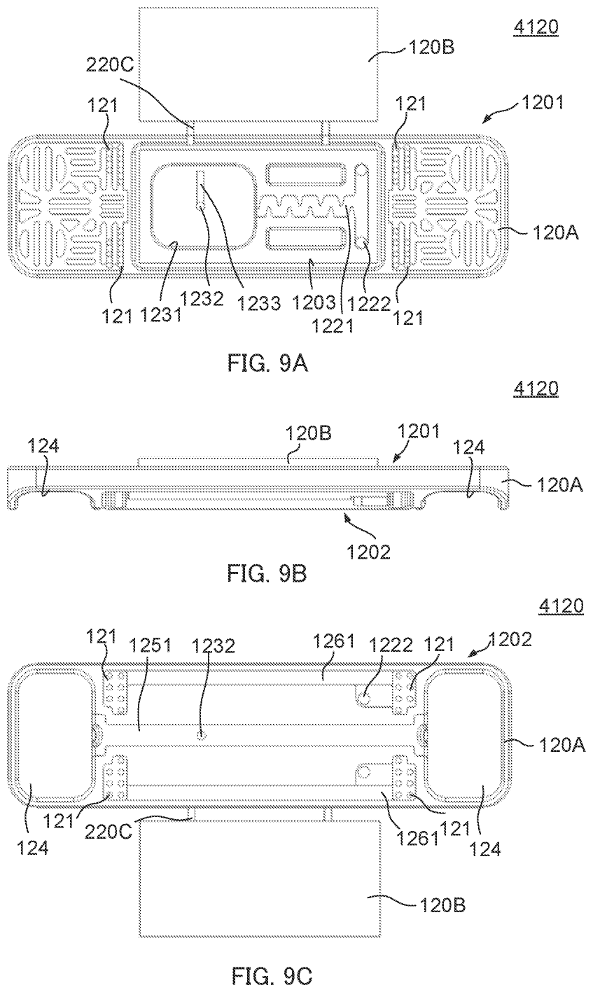

Further, FIGS. 8A and 8B illustrate a variation of emitter 120 of the embodiment described above. FIG. 8A is a perspective view of emitter 4120 of the variation, and FIG. 8B is a perspective view of emitter 4120 in which film 120B is rotated. In emitter 4120 in the variation, as illustrated in FIG. 8B, film 120B is rotatably attached to emitter main body 120A by hinge 220C. FIG. 9A illustrates a plan view of emitter 4120 in the state illustrated in FIG. 9B, FIG. 9B illustrates a front view of emitter 4120, FIG. 9C illustrates a bottom view of emitter 4120. Note that emitter 4120 in the variation has the same structure as emitter 120 of the above embodiment except for hinge 220C. Therefore, the same components are denoted by the same reference numerals, and a detailed description thereof is omitted.

The structure of hinge 220C of emitter 4120 is not particularly limited as long as it is capable of supporting film 120B rotatably. As illustrated in FIG. 9A, two or more hinges 220C may be disposed, or only one sheet-like hinge may be disposed. Hinges 220C do not have to be at positions aligned parallel to the longitudinal direction of emitter main body 120A, but may be at positions aligned parallel to the transverse direction.

In addition, the material of hinges 220C is not particularly limited as long as the hinges can support film 120B rotatably, and may be the same as or different from the material of emitter main body 120A or film 120B.

Emitter 4120 according to the variation may be fabricated by integrally molding emitter main body 120A, film 120B, and hinges 220C. For example, when film 120B is formed of a material different from the material of emitter main body 120A, the film may be formed by double molding or the like.

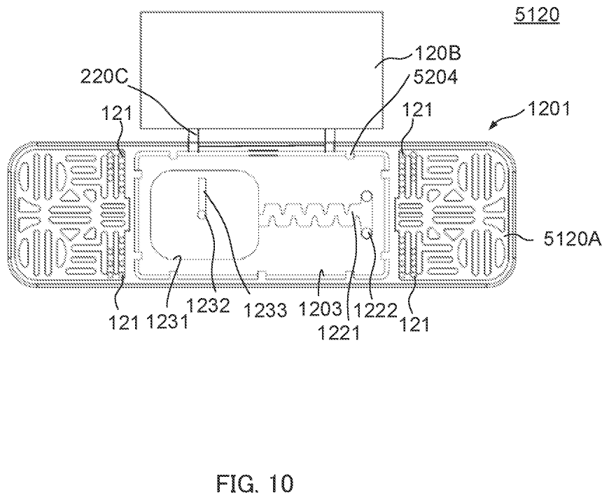

FIG. 10 illustrates a plan view of a further variation of above-described emitter 4120 illustrated in FIG. 8A. Emitter 5120 is similar to emitter 4120 of the above-described embodiment except for a difference of the shape of first surface 1201 of emitter main body 5120A. Therefore, the same components are denoted by the same reference numerals, and a detailed description thereof is omitted.

In emitter main body 5120A of emitter 5120, a plurality of claw portions 5204 for fixing film 120B are disposed on the opening end of first recess 1203. Each of claw portions 5204 has a plate-shaped structure protruding from the opening end of first recess 1203 toward the opposite side of the opening end, and the claw portions are disposed at substantially equal intervals on the inner circumference of first recess 1203. Claw portions 5204 are not particularly limited in width, length, thickness, and the like as long as the claw portions are capable of fixing film 120B to the bottom surface of first recess 1203 in emitter main body 1120A and do not interfere with the movement of the diaphragm portion (film 120B) during when the discharge rate of the irrigation liquid is regulated by discharge rate regulating part 123. It is preferable that claw portions 5204 be formed integrally with other regions forming emitter main body 5120A (for example, the side wall of first recess 1203).

Further, in the above-described embodiments, the bottom surface of second recess 1231 in discharge rate regulating part 123 is a flat surface, but the bottom surface of second recess 1231 does not have to be a flat surface. For example, the height of a region of the bottom surface of second recess 1231 situated around second communication hole 1232 may be higher than the height of the other region. In addition, the height of the region of the bottom surface of second recess 1231 situated around second communication hole 1232 may be lower than the height of the other region. Even in these cases, when the liquid pressure of the irrigation liquid rises, the bottom surface (the higher region or the lower region) of second recess 1231 functions as the pedestal of the diaphragm portion (film 120B), and the rate of the irrigation liquid to be discharged from discharging parts 124 can be regulated as described above. Further, in the above-described embodiment, pressure reducing channel 122 does not always have to be formed.

This application claims priority based on Japanese Patent Application No. 2019-208871 filed on Nov. 19, 2019. The disclosure of the specification, drawings and abstract of the Japanese Patent Application is incorporated in the specification of the present application by reference in its entirety.

### INDUSTRIAL APPLICABILITY

According to the emitter according to the present invention, the emitter can be installed in the tube without uniformly arranging the orientations of the discharging parts of emitters. Further, since the thickness of the emitter is small, the flow of the irrigation liquid is unlikely to be obstructed.

### REFERENCE SIGNS LIST

100 Drip irrigation tube
110 Tube
111 Discharging port
120, 1120, 2120, 3120, 4120, 5120 Emitter
120A, 1120A, 2120A, 3120A, 5120A Emitter main body
120B Film
121 Intake part
122 Pressure reducing channel
123 Discharge rate regulating part
124 Discharging part
125 Discharging channel
220C Hinge
1201 First surface of emitter main body
1202 Second surface of emitter main body
1203 First recess
1204, 5204 Claw portion
2205 Flange portion
3206 Cover portion
3206a Through hole
1221 Pressure reducing channel groove
1222 First communication hole
1231 Second recess
1232 Second communication hole
1233 Discharge rate regulating groove
1251 Discharging groove
1261 Introduction groove

1. An emitter for discharging an irrigation liquid in an irrigation-liquid-carrying tube at a fixed rate out of the irrigation-liquid-carrying tube from a discharging port of the irrigation-liquid-carrying tube that communicates between an inside and an outside of the irrigation-liquid-carrying tube, the emitter being configured to discharge the irrigation liquid in case that the emitter is joined to an inner wall surface of the irrigation-liquid-carrying tube at a position corresponding to the discharging port, the emitter comprising:
at least one intake part for intake of the irrigation liquid;
a discharge rate regulating part for regulating an amount of the irrigation liquid that is taken in from the at least one intake part and is to be discharged from the discharging port;
one discharging groove connected to the discharge rate regulating part; and
a plurality of discharging parts connected to the one discharging groove, the plurality of discharging parts being for discharging the irrigation liquid to the discharging port, wherein
the plurality of discharging parts are disposed at positions symmetrical with respect to a center of the emitter as seen in plan view.

2. The emitter according to claim 1, further comprising:
a pressure reducing channel between the at least one intake part and the discharge rate regulating part, the pressure reducing channel being for reducing a pressure of the irrigation liquid taken in from the at least one intake part, wherein
the plurality of discharging parts and the pressure reducing channel are disposed so as not to overlap one another in a thickness direction, and
the plurality of discharging parts and the discharge rate regulating part are disposed so as not to overlap one another in a thickness direction.

3. The emitter according to claim 2, wherein:
a number of the plurality of discharging parts is two, and
in the emitter as seen in plan view, the pressure reducing channel and the discharge rate regulating part are disposed between the two discharging parts.

4. The emitter according to claim 3, wherein
the two discharging parts are disposed symmetrically with respect to a center line that is perpendicular to a longitudinal direction of the emitter and extends in a transverse direction.

5. The emitter according to claim 2, further comprising:
an emitter main body including a first surface and a second surface having a relation between a front and a back with respect to each other, the first surface having the at least one intake part and a first recess, the second surface having the discharging groove and the plurality of discharging parts; and
a flexible film covering a bottom surface of the first recess in the emitter main body and having a thickness less than a depth of the first recess, wherein
the pressure reducing channel is a space delimited by a pressure reducing channel groove and the flexible film, the pressure reducing channel groove being disposed in the bottom surface of the first recess,
the discharge rate regulating part includes:
a second recess disposed in the bottom surface of the first recess and connected to the pressure reducing channel groove,
a communication hole communicating between the second recess and the discharging groove,
a discharge rate regulating groove disposed in a bottom surface of the second recess and opening in the communication hole, and
the flexible film covering the second recess, and
in case that pressure of the irrigation liquid in the irrigation-liquid-carrying tube is applied to the flexible film, the flexible film approaches an opening portion of the communication hole.

6. The emitter according to claim 2, wherein:
the at least one intake part comprises a plurality of intake parts, and
the emitter further comprises a plurality of introduction grooves connecting the plurality of intake parts to the pressure reducing channel.

7. A drip irrigation tube, comprising:
a tube comprising a discharging port for discharging an irrigation liquid; and
an emitter according to claim 1 joined to an inner wall surface of the tube, wherein
the discharging port of the tube and one of the plurality of discharging parts of the emitter are disposed so as to face each other.

8. The drip irrigation tube according to claim 7, wherein:
one of the plurality of discharging parts of the emitter is disposed so as to face the discharging port of the tube, and
a rest of the plurality of discharging parts is disposed so as not to face the discharging port of the tube.
